(19) United States
(12) Patent Application Publication
(10) Pub. No.: US 2023/0182784 A1
(43) Pub. Date: Jun. 15, 2023

(54) MACHINE-LEARNING-BASED STUCK DETECTOR FOR REMOTE ASSISTANCE

(71) Applicant: GM Cruise Holdings LLC, San Francisco, CA (US)

(72) Inventors: Da Fang, San Francisco, CA (US); Zisu Dong, Emeryville, CA (US); Ying Tan, Santa Clara, CA (US); Daniel Tien, San Francisco, CA (US); Atin Gupta, FREMONT, CA (US)

(21) Appl. No.: 17/550,721

(22) Filed: Dec. 14, 2021

(51) Int. Cl. B60W 60/00; G07C 5/00; G06V 20/56; G06N 20/00; G06K 9/62

(52) U.S. Cl. CPC B60W 60/0059; G06K 9/6259; G06N 20/00; G06V 20/56; G07C 5/008; B60W 2420/52

(57) ABSTRACT

The present technology is directed to determine that an autonomous vehicle needs remote assistance. The present technology may include receiving inputs into a stuck detection algorithm, the inputs including data descriptive of an environment in which the autonomous vehicle is located at a first time, objects surrounding the AV in the environment, data perceived by the autonomous vehicle prior to the first time, and events occurring in an AV stack leading up to a current state. The present technology may also include classifying the current AV state as stuck based on the received inputs by the stuck detection algorithm and initiating remote assistance session.

### TECHNICAL FIELD

The subject technology pertains to initiating remote assistance by using a machine-learning-based stuck detector to determine that an autonomous vehicle is stuck.

### BACKGROUND

An autonomous vehicle (AV) is a motorized vehicle that can navigate without a human driver. An exemplary autonomous vehicle includes a plurality of sensor systems, such as, but not limited to, a camera sensor system, a Light Detection and Ranging (LiDAR) sensor system, a radar sensor system, amongst others, wherein the autonomous vehicle operates based upon sensor signals output by the sensor systems. Specifically, the sensor signals are provided to an internal computing system in communication with the plurality of sensor systems, wherein a processor executes instructions based upon the sensor signals to control a mechanical system of the autonomous vehicle, such as a vehicle propulsion system, a braking system, or a steering system. In some applications, these systems utilize a perception system (or perception stack) that implements various computing vision techniques to reason about the surrounding environment.

### SUMMARY

The present technology is directed to determining that an autonomous vehicle needs remote assistance. The present technology may include receiving inputs into a stuck detection algorithm. The inputs include data descriptive of an environment in which the autonomous vehicle is located at a first time, objects surrounding the AV in the environment, data perceived by the autonomous vehicle prior to the first time, and events occurring in an AV stack leading up to a current state. The present technology may also include classifying the current AV state as stuck based on the received inputs by the stuck detection algorithm and initiating a remote assistance session.

Additional aspects, embodiments, and features are set forth in part in the description that follows and will become apparent to those skilled in the art upon examination of the specification or may be learned by the practice of the disclosed subject matter. A further understanding of the nature and advantages of the disclosure may be realized by reference to the remaining portions of the specification and the drawings, which form a part of this disclosure.

### BRIEF DESCRIPTION OF THE FIGURES

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example of a system for managing one or more Autonomous Vehicles (AVs) in accordance with some aspects of the present technology;

FIG. 2 is a block diagram illustrating a stuck detection algorithm for initiating remote assistance in accordance with some aspects of the present technology;

FIG. 3 is an example method for determining that an autonomous vehicle needs remote assistance in accordance with some aspects of the present technology;

FIG. 4 is a block diagram illustrating training the stuck detection algorithm in accordance with some aspects of the present technology; and

FIG. 5 is an example of a computing system in accordance with some aspects of the present technology.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology. In some instances, well-known structures and devices are shown in block diagram form to facilitate describing one or more aspects. Further, it is to be understood that functionality described as being carried out by certain system components may be performed by more or fewer components than shown.

As described herein, one aspect of the present technology is gathering and using data from various sources to improve the ride quality and ride experience for a passenger in an autonomous vehicle. The present disclosure contemplates that in some instances, this gathered data may include personal information. The present disclosure contemplates that the entities involved with such personal information respect and value privacy policies and practices.

Most autonomous vehicles (AVs) determine if they are blocking traffic and need remote assistance by detecting if the AVs have been stuck under a set of conditions for a threshold amount of time. However, because the AVs need to wait for the threshold amount of time, the AVs generally hold up traffic for at least the threshold amount of time before the AVs request remote assistance. During the threshold amount of time, the traffic situation may worsen.

A conventional method for determining AV stuck is a timer-based heuristic, which is also referred to as a heuristic timer. However, the heuristic timer may create an operational burden due to high false-positive rates (e.g., 64% of sessions initiated by the stuck timer do not require advisor action).

Aspects of the disclosed technology address the foregoing limitations of conventional time-based heuristics by a machine-learning-based detector that can detect high traffic impedance or vehicle stuck events based upon environment data more quickly and reliably. The present technology also pertains to training the stuck detection algorithm.

The machine learning (ML)-based stuck detector receives sensor data from an autonomous vehicle (AV) and quickly detects whether the AV is in a situation where remote assistance is needed (e.g., AV is stuck in an intersection and/or is blocking traffic).

The ML-based stuck detector can evaluate actions and predict stuck probability without remote assistance (RA) session for the AV. The ML-based stuck detector can initiate a remote assistance session when a stuck event is detected. The ML-based stuck detector evaluates action candidates when provided online access to current state information of the AV and when given a potential or executed AV action. The ML-based stuck detector is AV-centric because the primary concerns are road events that result from actions taken by the AV. The ML-based stuck detector is also action-based because the anomalous event predictions (e.g. stuck event) are based on an action planned or taken by the AV. The road events may include situations like an AV collision, the AV getting stuck somewhere, the AV blocking a region that it should not, among others.

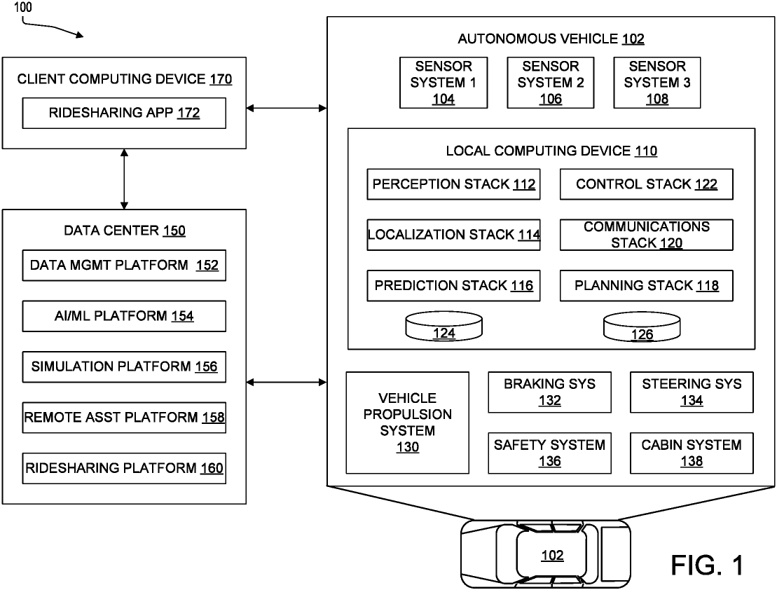

FIG. 1 illustrates an example of an AV management system 100. One of the ordinary skills in the art will understand that there can be additional or fewer components in similar or alternative configurations for the AV management system 100 and any system discussed in the present disclosure. The illustrations and examples provided in the present disclosure are for conciseness and clarity. Other embodiments may include different numbers and/or types of elements, but one of the ordinary skills in the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, sensor system 104 can be a camera system, sensor system 106 can be a LIDAR system, and sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV’s environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV’s position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along with the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV’s steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user’s mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112 - 122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine-learning algorithms that are incorporated in the local computing device 110.

The data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine-learning (AI/ML) platform 154, a simulation platform 156, remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine-learning algorithms for operating the AV 102, the simulation platform 156, the remote assistance platform 158, the ridesharing platform 160, and other platforms and systems. Using the AI/ML platform 154, data scientists can prepare data sets from the data management platform 152; select, design, and train machine-learning models; evaluate, refine, and deploy the models; maintain, monitor, and retrain the models; and so on.

The simulation platform 156 can enable testing and validation of the algorithms, machine-learning models, neural networks, and other development efforts for the AV 102, the remote assistance platform 158, the ridesharing platform 160, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other systems of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general-purpose computing devices for accessing the ridesharing application 172. The client computing device 170 can be a customer’s mobile computing device or a computing device integrated with the AV 102 (e.g., the local computing device 110). The ridesharing platform 160 can receive requests to pick up or drop off from the ridesharing application 172 and dispatch the AV 102 for the trip.

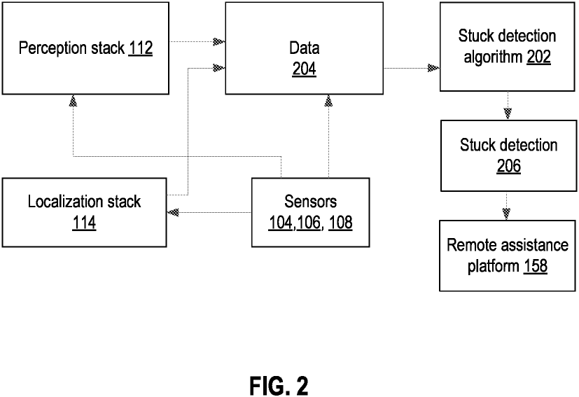

FIG. 2 is a block diagram illustrating a stuck detection algorithm for initiating remote assistance in accordance with some aspects of the present technology. As shown in FIG. 2, a stuck detection algorithm 202 is an ML-based stuck detector that determines that the AV is stuck based upon the predicted probability of being in a stuck state using data 204 and action candidates from the planning stack 118 and outputs a stuck detection 206 classification. The stuck detection algorithm 202 runs online on the AV while the AV is being autonomously piloted. The stuck detection algorithm 202 may confirm a stuck event or deny a stuck event.

The stuck detection algorithm 202 can communicate with remote assistance platform 158 to initiate remote assistance call when the stuck detection algorithm 202 detects that the AV is stuck and outputs stuck detection 206 classification. The remote assistance platform 158 will take over control of the AV upon receiving the stuck detection 206 classification from stuck detection algorithm 202.

Data 204 may be received from the perception stack 112 and/or the localization stack 114, which receives sensor data from sensors 104, 106, 108, as described with respect to FIG. 1 earlier. The data 204 may also be received from the sensors 104, 106, 108 directly. Data 204 may include data descriptive of an environment in which the autonomous vehicle is located at a first time, objects surrounding the AV in the environment. The data 204 may also include data perceived by the autonomous vehicle prior to the first time and events occurring in an AV stack leading up to a current state.

The stuck detection algorithm 202 may also check road traffic impedance. The road traffic impedance is defined by the travel time for a non-player character (NPC) between a source or starting point and a target or destination point. High traffic impedance is associated with a long travel time between the starting point and the destination point. When the travel time exceeds a time threshold, the vehicle is considered stuck. When the traffic impedance is high, the AV is stuck and therefore impede traffic. Factors influencing road traffic impedance may include the number of lanes, speed limit, intersection density, accidents, road constructions, or road blockages, among others. For example, the traffic impedance is affected by a red light at an intersection, a slow pedestrian crossing the street in front of the AV, or the intersection blocked or road blocked by an emergency vehicle.

More scenarios may cause the AV to be stuck on roads. For example, the AV may be stuck when the road may be too narrow for the AV to pass by. Also, the AV may be behind a large vehicle stuck on a road, such that some sensors on the AV are blocked by the large vehicle. Because the AV cannot reverse driving, the AV may be stuck behind the large vehicle. Further, the AV may be stuck if there is a false positive pedestrian detection. Additionally, the AV may be stuck when the road is under construction, the map is not updated yet, or when accidents happen on the road to cause a traffic jam, and the AV needs to go through a different route to avoid the traffic jam.

The AV may also encounter some anomaly situations other than being stuck on the road. When anomaly situations occur, the AV may need to initiate remote assistance. For example, the anomaly situation may be that a pedestrian may try to attack the AV. In this case, the AV may need quick remote assistance.

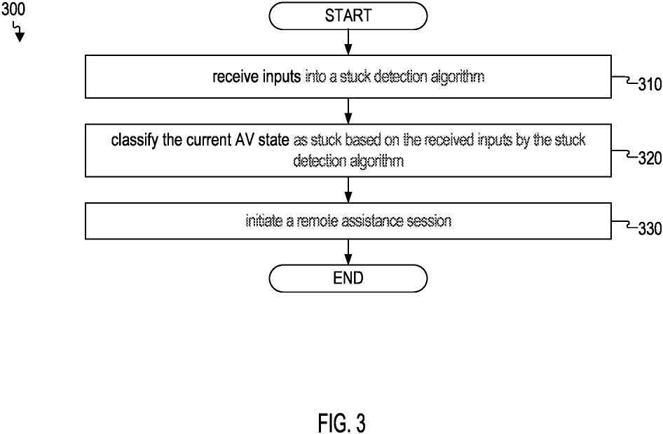

FIG. 3 illustrates an example method 300 for determining that an autonomous vehicle needs remote assistance in accordance with some aspects of the present technology. Although example method 300 depicts a particular sequence of operations, the sequence may be altered without departing from the scope of the present disclosure. For example, some of the operations depicted may be performed in parallel or in a different sequence that does not materially affect the function of method 300. In other examples, different components of an example device or system that implements the method 300 may perform functions at substantially the same time or in a specific sequence.

According to some examples, method 300 include receiving inputs into a stuck detection algorithm at block 310. For example, the stuck detection algorithm 202, as illustrated in FIG. 2, may receive inputs including data descriptive of an environment in which the autonomous vehicle is located at a first time, objects surrounding the AV in the environment, data perceived by the autonomous vehicle prior to the first time, and events occurring in an AV stack leading up to a current state.

In some variations, the stuck detection algorithm 202 may receive data from the perception stack 112 and the localization stack 114, wherein the perception stack 112 is configured to receive data from a plurality of sensors and output identifications of objects and record paths of the objects, wherein the localization stack 114 is configured to receive data from a plurality of sensors and a map and output a location of the autonomous vehicle on the map.

In some variations, the data descriptive of an environment in which the autonomous vehicle is located at a first time comes from the perception stack 112 of the autonomous vehicle.

In some variations, the data descriptive of an environment in which the autonomous vehicle is located at a first time comes from the localization stack 114 of the autonomous vehicle.

In some variations, the stuck detection algorithm 202 may receive data 204 directly from sensors 104, 106, 108 of the autonomous vehicle and stored maps without input from the prediction stack 116 or the planning stack 118, which are described earlier with respect to FIG. 1.

According to some examples, method 300 may include classifying the current AV state as stuck based on the received inputs at block 320. For example, the stuck detection algorithm 202, as illustrated in FIG. 2, may classify the current AV state as stuck based on the received inputs. For example, the stuck detection algorithm 202 may classify the current AV state as stuck, and output a stuck detection 206 classification. The received inputs include data 204, either directly from the sensors 104, 106, or 108 as illustrated in FIG. 2, or from the perception stack 112 or the localization stack 114, which are described with respect to FIG. 1.

According to some examples, method 300 may include initiating a remote assistance session at block 330. For example, the stuck detection algorithm 202, as illustrated in FIG. 2, may initiate remote assistance sessions. For example, the remote assistance platform 158 receives the stuck detection 206 from the stuck detection algorithm 202 and takes control of the AV.

Once the remote assistance is initiated, a remote assistance administrator in the remote assistance platform 158 may take over and remotely pilot the AV out of the stuck situation. For example, the remote assistance administrator may decide if the AV may go to another trajectory if the intersection is blocked. The remote assistance administrator may send another AV over, among others. Sometimes, the remote assistance administrator may also choose not to take any action.

When the stuck situation of the AV may be resolved, and the AV starts to move again, the remote assistance administrator can exit from the RA session that the stuck detection algorithm initiates.

The stuck detection algorithm 202 is used online on AVs. The stuck detection algorithm 202 is obtained offline by training a machine-learning (ML) algorithm and simulating AV’s surrounding environments.

The ML algorithms or models of the disclosed technology can be based on ML systems that include generative adversarial networks (GANs) that are trained, for example, using pairs of labeled (output) and unlabeled (input) images. An autonomous vehicle control system collects camera data and LiDAR data. The LiDAR data include 3D locations, intensities, and ranges (e.g., distances from the LiDAR sensor to objects). In some aspects, the unlabeled (input) images can be provided based on LiDAR map data, for example, that is produced from a rasterized high-resolution three-dimensional LiDAR map. As such, the disclosed labeler can perform image-to-image translation, wherein input images (based on LiDAR data) are labeled through the insertion of geometric bounding boxes and association with semantic labels. The labeled (output) images provided by the labeling system can then be utilized by AVs to quickly determine driving boundaries and to facilitate navigation and route planning functions.

The ML-based stuck detector may use one label for Stuck TKO = True and another label for Stuck TKO = False. The ML-based stuck detector may use a single tick where the Stuck TKO occurs for positive cases. The ML-based stuck detector may use false positive RA calls for negative cases.

As understood by those of skill in the art, ML-based classification techniques can vary depending on the desired implementation. For example, ML classification schemes can utilize one or more of the following, alone or in combination: hidden Markov models, recurrent neural networks (RNNs), convolutional neural networks (CNNs); Deep Learning networks, Bayesian symbolic methods, general adversarial networks (GANs), support vector machines, image registration methods, and/or applicable rule-based systems. Regression algorithms can be used, including Stochastic Gradient Descent Regressors and/or Passive-Aggressive Regressors, among others.

ML classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, ML models can employ a dimensionality reduction approach, such as one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

By using the ML algorithm, AVs can perform many of the functions conventionally performed by human drivers, such as avoiding collision and performing other navigation and routing tasks necessary to provide safe and efficient transportation. However, the ML algorithm is as good as the quality and volume of data it is trained with. For example, the ML algorithm can be trained to recognize the difference among various objects, such as vehicles, bicycles, and pedestrians. The ML algorithm can also be trained to detect a stuck vehicle. The ML algorithm can also be trained with various scenarios. The more scenarios are generated in simulations for training, the ML algorithm can perform better than that solely based on real-world captured data.

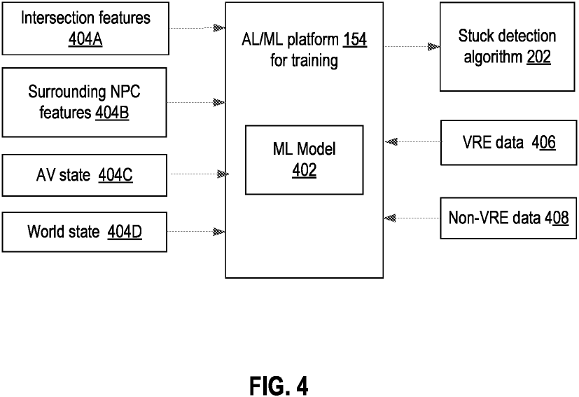

FIG. 4 is a block diagram illustrating training the stuck detection algorithm in accordance with some aspects of the present technology. The ML-based stuck detector may be trained by simulating AV’s surrounding environment, such as by adding nearby objects, high-dimension map information, lane state, to determine if an autonomous vehicle impedes traffic in real-time.

The AI/ML platform 154 may train ML model or algorithm 402 to output the stuck detection algorithm 202 by adding simulated intersection features 404A, surrounding non-player characters (NPC) features 404B, AV state 404C, or world state 404D, among others. The intersection features 404A may include distance to front intersections or intersection type, among others. The surrounding NPC features 404B may include varying distance or angle to the intersection ahead of the AV or other front obstacles, moving confidence of the AV or other front obstacles, or object size, category of NPC, among others. The AV state 404C may include how long the AV has stopped or whether the AV is making a turn, among others. The world-state 404D may include traffic light state or lane type, among others. The ML algorithm 402 may also be trained by using more VRE data 406 or non-VRE data 408.

According to some examples, a method may include training a machine-learning algorithm to result in the stuck detection algorithm. For example, the AI/ML platform 154 illustrated in FIGS. 1 and 4 may train a machine-learning algorithm 402 to result in the stuck detection algorithm 202.

According to some examples, the method for training a machine-learning algorithm may include creating a labeled dataset including events from real-world driving data, the real-world driving data including data from takeover (TKO) events by an AV supervisor when the AV is stuck. For example, the AI/ML platform 154 illustrated in FIGS. 1 and 4 may create a labeled dataset including events from real-world driving data. The real-world driving data includes data from takeover (TKO) events by an AV supervisor when the AV is stuck.

### Examples

The following examples are for illustration purposes only. It will be apparent to those skilled in the art that many modifications, both to materials and methods, may be practiced without departing from the scope of the disclosure.

Vehicle Retrieval Events (VREs) are highly undesirable customer experiences from a business aspect since VREs may cause AV passengers to be stuck within the AV for an indefinite period and may negatively impact public perception. The AV passengers may feel unsafe when stuck in the AV without remote assistance. The stuck detection algorithm 202 provides a solution to catch VREs promptly. The overall impact of the ML-based stuck detector in VRE-initialization-failure is that the VRE-initialization-failure are reduced from 33% without the ML-based stuck detector to about 3% with the ML-based stuck detector.

The on-road VRE-proxy performance can be improved by using the ML-based stuck detector. For example, a prior method of identifying VRE events had 13 VRE-initiation-failures per 1k miles. The present technology reduced that number to 6 VRE-initiation-failure per 1k miles.

In contrast, the conventional heuristic timer may cause low VRE recall. For example, VREs may be caused by not connecting to an advisor on time when the AV gets stuck. The heuristic timer cannot capture VRE events for various stuck cases in all-way stop (AWS) intersections, narrow gap, or deadlock.

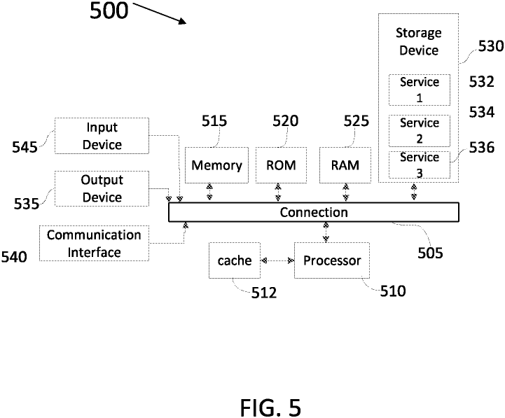

FIG. 5 shows an example of computing system 500, which can be, for example, used for all the calculations as discussed above, or can be any computing device making up the local computing system 110, remote computing system 150, (potential) passenger device executing rideshare app 170, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

The example system 500 includes at least one processing unit (CPU or processor) 510 and connection 505 that couples various system components including system memory 515, such as read-only memory (ROM) 520 and random access memory (RAM) 525 to processor 510. Computing system 500 can include a cache of high-speed memory 512 connected directly with, close to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of many output mechanisms known to those of skill in the art. In some instances, multimodal systems can enable a user to provide multiple types of input/output to communicate with computing system 500. Computing system 500 can include communications interface 540, which can generally govern and manage the user input and system output. There is no restriction on operating on any particular hardware arrangement, and therefore the basic features here may easily be substituted for improved hardware or firmware arrangements as they are developed.

Storage device 530 can be a non-volatile memory device and can be a hard disk or other types of computer-readable media which can store data that are accessible by a computer, such as magnetic cassettes, flash memory cards, solid-state memory devices, digital versatile disks, cartridges, random access memories (RAMs), read-only memory (ROM), and/or some combination of these devices.

The storage device 530 can include software services, servers, services, etc., and when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in the memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware, and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed:

1. A method for determining that an autonomous vehicle needs remote assistance, the method comprising:
receiving inputs into a stuck detection algorithm, the inputs including data descriptive of an environment in which the autonomous vehicle is located at a first time, objects surrounding the AV in the environment, data perceived by the autonomous vehicle prior to the first time, and events occurring in an AV stack leading up to a current state;
classifying the current AV state as stuck based on the received inputs by the stuck detection algorithm; and
initiating remote assistance session.

2. The method of claim 1, further comprising training a machine-learning algorithm to result in the stuck detection algorithm.

3. The method of claim 2, wherein the training the machine-learning algorithm comprises:
creating a labeled dataset including events from real-world driving data, the real-world driving data including data from takeover (TKO) events by an AV supervisor when the AV is stuck, events resulting in calls for remote assistance where a remote operator determines that the AV is stuck, and events resulting in calls for remote assistance where a remote operator determines that the AV is not stuck.

4. The method of claim 1, wherein the stuck detection algorithm is run online on the AV while the AV being autonomously piloted.

5. The method of claim 1, wherein the stuck detection algorithm receives data from a perception stack and a localization stack, wherein the perception stack is configured to receive data from a plurality of sensors and output identifications of objects and record paths of the objects, wherein the localization stack is configured to receive data from a plurality of sensors and a map and output a location of the autonomous vehicle on the map.

6. The method of claim 5, wherein the data descriptive of an environment in which the autonomous vehicle is located at a first time comes from a perception stack of the autonomous vehicle.

7. The method of claim 5, wherein the data descriptive of an environment in which the autonomous vehicle is located at a first time comes from a localization stack of the autonomous vehicle.

8. The method of claim 1, wherein the stuck detection algorithm receives data directly from sensors of the autonomous vehicle and stores maps without input from a prediction stack or a planning stack.

9. A system comprising:
a storage configured to store instructions;
a processor configured to execute the instructions and cause the processor to:
receive inputs into a stuck detection algorithm, the inputs including data descriptive of an environment in which the autonomous vehicle is located at a first time, objects surrounding the AV in the environment, data perceived by the autonomous vehicle prior to the first time, and events occurring in an AV stack leading up to a current state,
classify the current AV state as stuck based on the received inputs by the stuck detection algorithm, and
initiate remote assistance session.

10. The system of claim 9, wherein the processor is configured to execute the instructions and cause the processor to: train a machine-learning algorithm to result in the stuck detection algorithm.

11. The system of claim 10, wherein the processor is configured to execute the instructions and cause the processor to:
create a labeled dataset including events from real-world driving data, the real-world driving data including data from takeover (TKO) events by an AV supervisor when the AV is stuck events resulting; and
call for remote assistance where a remote operator determines that the AV is stuck, and events resulting in calls for remote assistance where a remote operator determines that the AV is not stuck.

12. The system of claim 9, wherein the stuck detection algorithm is run online on the AV while the AV being autonomously piloted.

13. The system of claim 9, wherein the stuck detection algorithm receives data from a perception stack and a localization stack the perception stack is configured to receive data from a plurality of sensors and output identifications of objects and record paths of the objects, and the localization stack is configured to receive data from a plurality of sensors and a map and output a location of the autonomous vehicle on the map.

14. The system of claim 13, wherein the data descriptive of an environment in which the autonomous vehicle is located at a first time comes from a perception stack of the autonomous vehicle, wherein the data descriptive of an environment in which the autonomous vehicle is located at a first time comes from a localization stack of the autonomous vehicle,.

15. The system of claim 9, wherein the stuck detection algorithm receives data directly from sensors of the autonomous vehicle and stores maps without input from a prediction stack or a planning stack.

16. A non-transitory computer readable medium comprising instructions, the instructions, when executed by a computing system, cause the computing system to:
receive inputs into a stuck detection algorithm, the inputs including data descriptive of an environment in which the autonomous vehicle is located at a first time, objects surrounding the AV in the environment, data perceived by the autonomous vehicle prior to the first time, and events occurring in an AV stack leading up to a current state;
classify the current AV state as stuck based on the received inputs by the stuck detection algorithm; and
initiate remote assistance session.

17. The computer readable medium of claim 16, wherein the computer readable medium further comprises instructions that, when executed by the computing system, cause the computing system to: train a machine-learning algorithm to result in the stuck detection algorithm.

18. The computer readable medium of claim 18, wherein the computer readable medium further comprises instructions that, when executed by the computing system, cause the computing system to:
create a labeled dataset including events from real-world driving data, the real-world driving data including data from takeover (TKO) events by an AV supervisor when the AV is stuck, events resulting; and
call for remote assistance where a remote operator determines that the AV is stuck, and events resulting in calls for remote assistance where a remote operator determines that the AV is not stuck.

19. The computer readable medium of claim 16, wherein the stuck detection algorithm receives data from a perception stack and a localization stack, the perception stack is configured to receive data from a plurality of sensors and output identifications of objects and record paths of the objects, and the localization stack is configured to receive data from a plurality of sensors and a map and output a location of the autonomous vehicle on the map.

20. The computer readable medium of claim 16, the stuck detection algorithm receives data directly from sensors of the autonomous vehicle and stores maps without input from a prediction stack or a planning stack.
